(19) United States
(12) Patent Application Publication
(10) Pub. No.: US 2025/0297990 A1
(43) Pub. Date: Sep. 25, 2025

(54) ULTRASONIC DETECTION METHOD, ULTRASONIC REPAIR METHOD, AND ULTRASONIC DEVICE

(71) Applicant: HKC CORPORATION LIMITED, Shenzhen (CN)

(72) Inventors: YAO LI, Shenzhen (CN); Chuan WU, Shenzhen (CN); Zhonglin CAO, Shenzhen (CN); Tianjun HUANG, Shenzhen (CN); Haijiang YUAN, Shenzhen (CN)

(21) Appl. No.: 19/068,026

(22) Filed: Mar. 3, 2025

(30) Foreign Application Priority Data
Mar. 19, 2024 (CN) 202410330350.8

(51) Int. Cl. G01N 29/04; B29C 35/02

(52) U.S. Cl. CPC G01N 29/048; B29C 35/0261; G01N 2291/023

(57) ABSTRACT

An ultrasonic detection method, an ultrasonic repair method, and an ultrasonic device are disclosed. The ultrasonic detection method includes: sending a piece of first ultrasonic information to an encapsulation layer of the display panel; receiving a piece of second ultrasonic information fed back from the encapsulation layer of the display panel, and analyzing whether the encapsulation layer of the display panel has a crack of a preset condition according to the second ultrasonic information; if the encapsulation layer of the dis-play panel does not have a crack of the preset condition, sending the display panel to a next procedure; if a crack of preset condition is found in the encapsulation layer of the display panel, performing a subsequent preset operation according to a test result and a preset rule.

### CROSS-REFERENCE TO RELATED APPLICATIONS

This application claims the priority and benefit of Chinese patent application number 2024103303508, titled “Ultrasonic Detection Method, Ultrasonic Repair Method, and Ultrasonic Device” and filed Mar. 19, 2024 with China National Intellectual Property Administration, the entire contents of which are incorporated herein by reference.

### TECHNICAL FIELD

This application relates to the field of ultrasonic technology, and more particularly relates to an ultrasonic detection method, an ultrasonic repair method, and an ultrasonic device.

### BACKGROUND

The description provided in this section is intended for the mere purpose of providing background information related to the present application but doesn't necessarily constitute prior art.

Organic light emitting diodes (OLEDs) have poor stability and are extremely sensitive to water, oxygen, and heat, so the encapsulation technique is particularly critical. Since a flexible bendable screen has to go through many bending and deformation sessions, the encapsulation layer is prone to cracks, which will accelerate the aging speed of the OLED organic light-emitting layer device. Therefore, strict encapsulation must be performed to extend the life and improve stability.

During the manufacturing of the display panel, multiple encapsulations may be performed. During the encapsulation of the display panel, defects in a prepared film layer may occur due to problems related to e.g. the processing equipment and the manufacturing process. That is, failures of varying degrees may occur during the preparation of the film layer, such as cracks. If the product with such defects is not intercepted in time and proceeds to enter the preparation of the next film layer, the failure position will exist in the product, which may directly affect the film formation quality of the next film layer at this position, or the product may fail quickly in subsequent use, resulting in even more serious consequences.

Therefore, how to improve the real-time detection of whether the display panel has film defects and deal with these defects in time has become an urgent problem to be solved.

### SUMMARY

It is therefore one purpose of this application to provide an ultrasonic detection method, an ultrasonic repair method, and an ultrasonic device for real-time detection and improving the overall yield of the product.

The present application discloses an ultrasonic detection method for detecting an encapsulation layer of a display panel, the ultrasonic detection method comprising:
sending a first ultrasonic information to the encapsulation layer of the display panel;
receiving a second ultrasonic information fed back from the encapsulation layer of the display panel, and analyzing whether the encapsulation layer of the display panel has a crack of a preset condition according to the second ultrasonic information;
if no crack of the preset condition is found in the encapsulation layer of the display panel, sending the display panel to a next procedure;
if it is found that the encapsulation layer of the display panel has a crack of the preset condition, performing a subsequent preset operation according to the test result and a preset rule.

In some embodiments, before the operation of sending the first ultrasonic information to the encapsulation layer of the display panel, the following operations are further included:
transferring the display panel to a carrier;
the carrier recognizing a mark of a specific shape of the display panel and a terminal ID of the display panel;
establishing a corresponding coordinate system according to the mark of the specific shape and tagging the terminal ID.

In some embodiments, the operation of sending the first ultrasonic information to the encapsulation layer of the display panel includes:
based on the coordinate system, sending the first ultrasonic information to the encapsulation layer of the display panel in sequence;
wherein the operation of receiving a second ultrasonic information fed back from the encapsulation layer of the display panel, and analyzing whether the encapsulation layer of the display panel has a crack of a preset condition according to the second ultrasonic information includes:
comparing the received second ultrasonic information against a preset condition;
determining whether the encapsulation layer of the display panel has a crack according to the comparison result;
tagging the display panel according to the determination.

In some embodiments, the mark includes information directed to an evaluated level of the crack. The operation of if the display panel is found to have a crack then performing the subsequent preset operation according to the test result includes:
if the evaluated crack level of the display panel does not reach a scrapping standard, performing a repair operation on the display panel;
if the evaluated crack level of the display panel reaches the scrapping standard, scrapping the display panel.

In some embodiments, before the operation of sending the first ultrasonic information to the encapsulation layer of the display panel, the following operations are further included:
arranging the ultrasonic device and the display panel relative to each other, and controlling a distance between the ultrasonic transmitter module of the ultrasonic detection device and the display panel to lie in the range of 10 cm to 30 cm.

The present application further discloses an ultrasonic repair method for repairing the display panel as described above, the ultrasonic repair method including the following operations:
transferring the display panel having the crack of the preset condition to a corresponding position;
irradiating the position of the crack with ultrasonic waves to complete the ultrasonic repair operation by local heating.

In some embodiments, before the operation of irradiating the position of the crack with ultrasonic waves to complete the ultrasonic repair operation by local heating, the following operation is further included:
confirming the location of the crack of the preset condition in the corresponding coordinate system according to the test result of the display panel.

In some embodiments, the operation of irradiating the position of the crack with ultrasonic waves to complete the ultrasonic repair operation by local heating includes:
irradiating the coordinate point confirmed to have the crack of the preset condition and the area with a diameter of 100 um-200 um around the coordinate point with ultrasonic waves.

In some embodiments, the coordinate point of the crack of the preset condition is divided into a plurality of sub-coordinate points, and the operation of irradiating the position of the crack with ultrasonic waves to complete the ultrasonic repair operation by local heating includes:
based on the distributed positions of the plurality of sub-coordinate points, sequentially irradiating ultrasonic waves to complete the ultrasonic repair operation by local heating.

The present application further discloses an ultrasonic repair method for repairing the display panel as described above, the ultrasonic repair method including:

Compared with the related art, the present application adopts an ultrasonic detection method for detecting the encapsulation layer of the display panel, the ultrasonic detection method including: sending a first ultrasonic information to the encapsulation layer of the display panel; receiving a second ultrasonic information fed back from the encapsulation layer of the display panel, and analyzing whether the encapsulation layer of the display panel has a crack of the preset condition according to the second ultrasonic information; if the encapsulation layer of the display panel is not found to have a crack of the preset condition, sending the display panel to the next program; if the encapsulation layer of the display panel is found to have a crack of the preset condition, performing a subsequent preset operation according to the test result and the preset rule. In this way, after the display panel is manufactured, ultrasonic detection can be used to detect whether the encapsulation layer has cracks, meaning real-time monitoring can be carried out, and the display panel with cracks can be repaired in time to improve the overall yield of the product.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principles of the present application in conjunction with the text description. Apparently, the drawings in the following description merely represent some embodiments of the present disclosure, and for those having ordinary skill in the art, other drawings may also be obtained based on these drawings without investing creative. In the drawings:

FIG. 1 is a flowchart of an ultrasonic detection method provided in an embodiment of the present application.

FIG. 2 is a flowchart of operations prior to operation S1 illustrated in FIG. 1.

FIG. 3 is a flowchart of other operations prior to operation S1 illustrated in FIG. 1.

FIG. 4 is a schematic diagram of an ultrasonic device provided in an embodiment of the present application.

FIG. 5 is a further detailed flowchart of operation S1 illustrated in FIG. 1.

FIG. 6 is a further detailed flowchart of operation S2 illustrated in FIG. 1.

FIG. 7 is a further detailed flowchart of operation S4 illustrated in FIG. 1.

FIG. 8 is a flowchart of an ultrasonic repair method provided in an embodiment of the present application.

FIG. 9 is a further detailed flowchart of operation S10 illustrated in FIG. 8.

FIG. 10 is a flowchart of operations subsequent to operation S12 illustrated in FIG. 8.

FIG. 11 is a flowchart of another operation subsequent to operation S12 illustrated in FIG. 8.

In the drawings: 100, ultrasonic device; 110, ultrasonic device body; 120, ultrasonic transmitter module; 130, ultrasonic receiver module; 140, processor.

### DETAILED DESCRIPTION OF EMBODIMENTS

It should be understood that the terms used herein, the specific structures and functional details disclosed therein are merely representative for describing some specific embodiments, but the present application can be implemented in many alternative forms and should not be construed as being limited to only these embodiments described herein.

As used herein, terms “first”, “second”, or the like are merely used for illustrative purposes, and shall not be construed as indicating relative importance or implicitly indicating the number of technical features specified. Thus, unless otherwise specified, the features defined by “first” and “second” may explicitly or implicitly include one or more of such features. Terms “multiple”, “a plurality of”, and the like mean two or more. In addition, terms “up”, “down”, “left”, “right”, “vertical”, and “horizontal”, or the like are used to indicate orientational or relative positional relationships based on those illustrated in the drawings. They are merely intended for simplifying the description of the present disclosure, rather than indicating or implying that the device or element referred to must have a particular orientation or be constructed and operate in a particular orientation. Therefore, these terms are not to be construed as restricting the present disclosure. For those of ordinary skill in the art, the specific meanings of the above terms as used in the present application can be understood depending on specific contexts.

The present application will be described in detail below with reference to the accompanying drawings and some optional embodiments.

FIG. 1 is a schematic flowchart of an ultrasonic detection method provided by an embodiment of the present application. As shown in FIG. 1, the present application discloses an ultrasonic detection method for detecting an encapsulation layer of a display panel, the ultrasonic detection method including the following operations:

S1: sending a first ultrasonic information to the encapsulation layer of the display panel;

S2: receiving a second ultrasonic information fed back from the encapsulation layer of the display panel, and analyzing whether the encapsulation layer of the display panel has a crack of a preset condition according to the second ultrasonic information;

S3: If no crack of the preset condition is found in the encapsulation layer of the display panel, sending the display panel to a next procedure;

S4: if it is found that the encapsulation layer of the display panel has a crack of the preset condition, performing a subsequent preset operation according to the test result and a preset rule.

Compared with the related art, the present application adopts an ultrasonic detection method for detecting the encapsulation layer of the display panel, the ultrasonic detection method including: sending a first ultrasonic information to the encapsulation layer of the display panel; receiving a second ultrasonic information fed back from the encapsulation layer of the display panel, and analyzing whether the encapsulation layer of the display panel has a crack of the preset condition according to the second ultrasonic information; if the encapsulation layer of the display panel is not found to have a crack of the preset condition, sending the display panel to the next program; if the encapsulation layer of the display panel is found to have a crack of the preset condition, performing a subsequent preset operation according to the test result and the preset rule. In this way, after the display panel is manufactured, ultrasonic detection can be used to detect whether the encapsulation layer has cracks, meaning real-time monitoring can be carried out, and the display panel with cracks can be processed in time to improve the overall yield of the product.

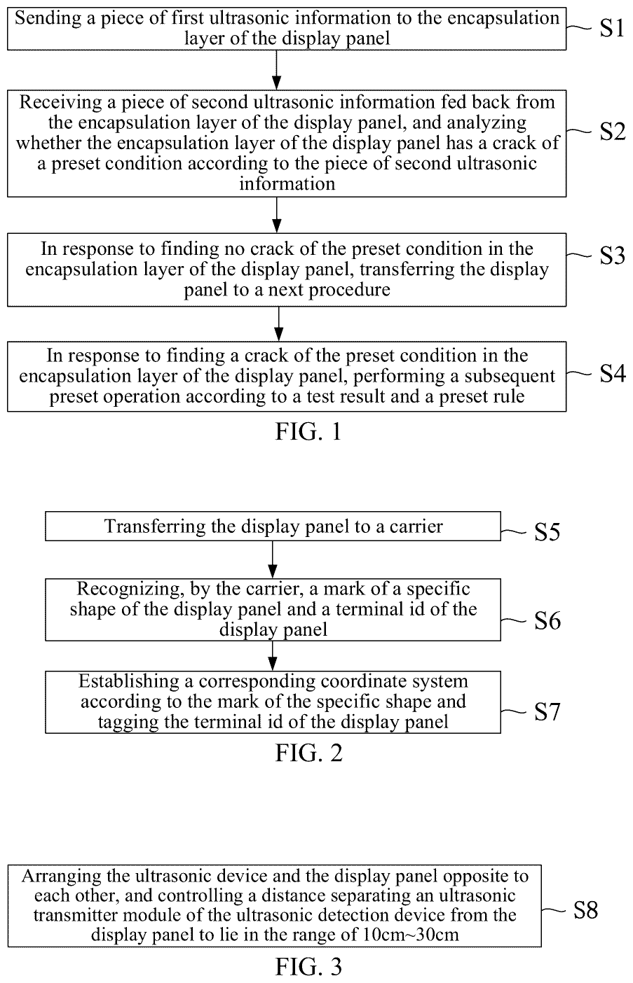

FIG. 2 is schematic flowchart of operations prior to operation S1 illustrated in FIG. 1. As shown in FIG. 2, before the operation of sending the first ultrasonic information to the encapsulation layer of the display panel, the following operations are further included:

S5: transferring the display panel to a carrier;

S6: the carrier recognizing a mark of a specific shape of the display panel and a terminal ID of the display panel;

S7: establishing a corresponding coordinate system according to the mark of the specific shape and tagging the terminal ID.

At this time, the carrier is provided with a detection lens for recognizing the display panel. The back plate of each display panel may use a metal layer to design a pattern through photolithography and development as the terminal ID, and there may be a mark of a specific shape on the display panel. The detection lens first recognizes the mark of the specific shape of the display panel, and then establishes a relative coordinate system. After the coordinate system of the entire display panel is fixed, the ultrasonic device may perform relative positional movement and detection on the coordinate system. If the display panel has cracks, it is recorded through the terminal ID. If the display panel does not have an abnormality, the display panel of the terminal ID is recorded as normal, and the display panel is directly sent to the next procedure.

FIG. 3 is a flowchart of other operations before operation S1 illustrated in FIG. 1. As shown in FIG. 3, therefore, before the operation of sending the first ultrasonic information to the encapsulation layer of the display panel, the following operations are further included:

S8: arranging the ultrasonic device and the display panel relative to each other, and controlling a distance between the ultrasonic transmitter module of the ultrasonic detection device and the display panel to lie in the range of 10 cm to 30 cm.

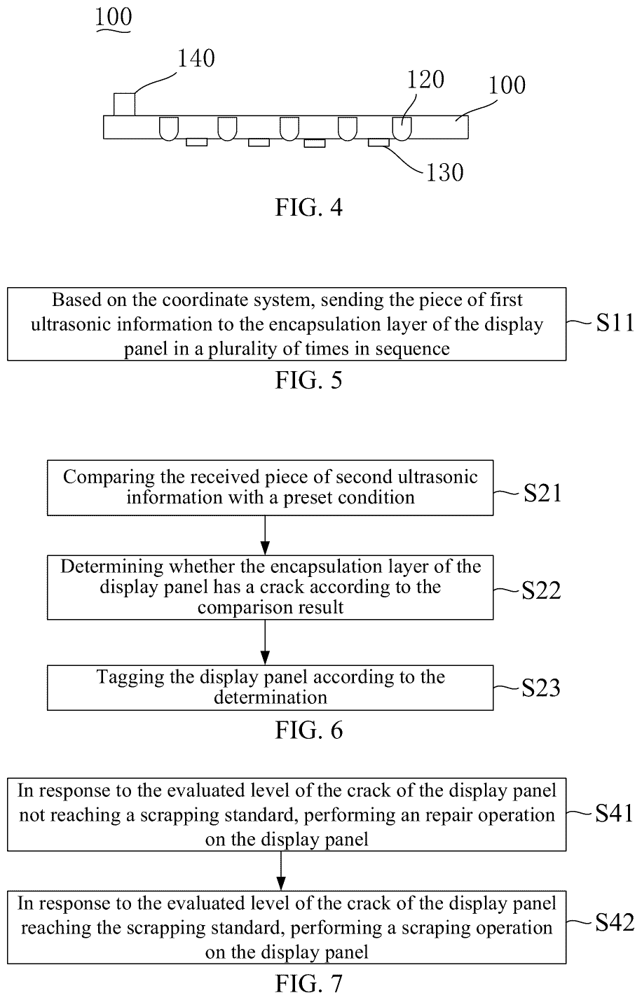

FIG. 4 is a schematic diagram of an ultrasonic device provided by an embodiment of the present application. As shown in FIG. 4, the present application further discloses an ultrasonic device, which can be used for crack detection of the encapsulation layer of the display panel as described above. The ultrasonic device includes an ultrasonic device body, multiple ultrasonic trans-mitter modules, multiple ultrasonic receiver modules, and a processor. The processor is arranged on a side of the ultrasonic device body. The multiple ultrasonic transmitter modules and the multiple ultrasonic receiver modules are arranged on the ultrasonic device body at intervals. The ultrasonic transmitter modules transmit the first ultrasonic information. The ultrasonic receiver modules receive the second ultrasonic information. The ultrasonic transmitter modules and the ultrasonic receiver modules are signal-connected to the processor.

The ultrasonic transmitter module emits ultrasonic waves in a certain direction. The timing starts at the same time as the time of emission. The ultrasonic wave propagates in the air and returns immediately when it encounters an obstacle on the way. The ultrasonic receiver module stops timing immediately when it receives the reflected waves. The propagation speed of ultrasonic waves in the air is 340 m/s. According to the time t (seconds) recorded by the timer, the distance(s) from the emission point to the obstacle can be calculated, that is: s=340 t/2.

FIG. 5 is a further detailed flowchart of operation S1 illustrated in FIG. 1. As shown in FIG. 5, the operation of sending the first ultrasonic information to the encapsulation layer of the display panel includes:

S11: based on the coordinate system, sending the first ultrasonic information to the encapsulation layer of the display panel in sequence.

FIG. 6 is a further detailed flowchart of operation S2 illustrated in FIG. 1. As shown in FIG. 6, the operation of receiving the second ultrasonic information fed back from the encapsulation layer of the display panel and analyzing whether the encapsulation layer of the display panel has a crack of a preset condition according to the second ultrasonic information includes:

S21: comparing the received second ultrasonic information against a preset condition;

S22: determining whether the encapsulation layer of the display panel has a crack according to the comparison result;

S23: tagging the display panel according to the determination.

Tagging the display panel may include making an electronic mark on the X-axis and Y-axis of the position based on the coordinate system, and generating a test result file, and recording them into the terminal ID of the display panel together. When the terminal ID is recognized, the recognition system may display all the information of the display panel and locate the coordinates where the crack exists, so as to facilitate viewing and subsequent operations.

FIG. 7 is a further detailed flowchart of operation S4 illustrated in FIG. 1. As shown in FIG. 7, the mark includes evaluated level of the crack. If the display panel is found to have a crack, then performing the subsequent preset operation according to the test result includes:

S41: if the evaluated crack level of the display panel does not reach a scrapping standard, performing a repair operation on the display panel;

S42: if the evaluated crack level of the display panel reaches the scrapping standard, scrapping the display panel.

As for the evaluation of cracks, more detailed detection equipment may be used for more targeted evaluation. If the crack is a non-penetrating crack, the length is more than 10 um and less than 1 mm, and the depth is within 1000 angstroms, it can be repaired. If it is a crack that penetrates the film layers, it cannot be repaired. At this time, the display panel will be directly scrapped.

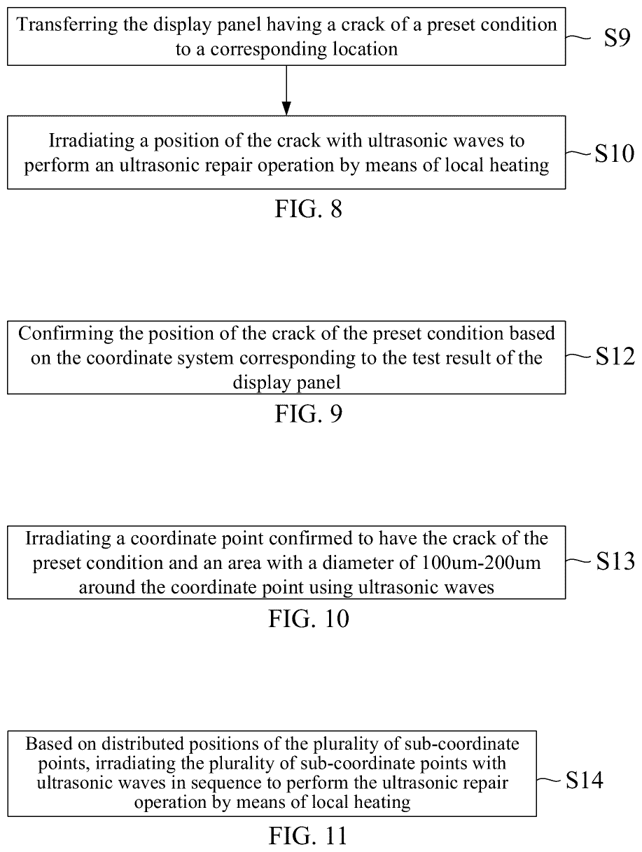

FIG. 8 is a schematic flowchart of an ultrasonic repair method provided in an embodiment of the present application. As shown in FIG. 8, for a display panel whose crack level does not meet the scrapping standard, repair is performed. Therefore, embodiments of the present application further discloses an ultrasonic repair method for performing a repair operation on the display panel as described above, the ultrasonic repair method including the following operations:

S9: transferring the display panel having the crack of the preset condition to a corresponding position;

S10: irradiating the position of the crack with ultrasonic waves to complete the ultrasonic repair operation by local heating.

Ultrasonic repair is achieved by ultrasonic plastic welding. The encapsulation layer of the display panel includes a first inorganic encapsulation layer, an organic encapsulation layer, and a second inorganic encapsulation layer. The organic encapsulation layer is located between the first inorganic encapsulation layer and the second inorganic encapsulation layer. An encapsulation cover plate is added to the side of the second inorganic encapsulation layer facing away from the first inorganic encapsulation layer to realize the encapsulation of the entire display panel. The second inorganic encapsulation layer may be doped with a material that is sensitive to ultrasonic welding, including non-crystalline plastics such as acrylonitrile-butadiene-styrene (ABS), poly(methyl methacrylate) (PMMA), polycarbonates (PC), Polystyrene (PS) and other materials; semi-crystalline plastics such as polyamide (PA), polyethylene terephthalate (PET), cellulose acetate polymer (CA), polyoxymethylene (POM), polyethylene (PE) and polypropylene (PP), in thermoplastics. Rigid materials such as polystyrene (PS), polymethyl methacrylate (PMMA), and polyamide (PA) are the optimal. Of course, for ultrasonic welding, non-woven fabrics such as thermoplastic fabrics, polymer materials, coated paper, and mixed fabrics may also be mixed in the second inorganic encapsulation layer. Other materials may also be selected, which are not limited here.

The display panel with a crack of the preset condition may be transported to an ultrasonic device for ultrasonic welding. The ultrasonic device may be the above-mentioned ultrasonic device with ultrasonic detection function. Therefore, the ultrasonic device further includes: a high-frequency current generator, where its main function is to convert the input low-frequency current into the output high-frequency current. Its frequency range is identical with the ultrasonic frequency range. a transducer, which converts a high-frequency current into a high-frequency mechanical vibration, that is, into ultrasonic wave; a welding tool, which is a tool to transmit ultrasonic energy to the display panel to be welded, and may be made of aluminum, titanium, or Monel alloy into a cone; a base, which supports the display panel to be welded, so that the display panel to be welded can be easily impacted by ultrasonic wave, where the base is made of a possible hard metal; a high-voltage generator, which is used to generate a certain pressure on the encapsulation layer to be repaired.

Principle of ultrasonic welding: When ultrasonic waves act on the contact surface of the encapsulation layer having a crack, high-frequency vibrations of tens of thousands of times per second are generated, and the ultrasonic energy is transmitted to the welding area through the above-mentioned welding tool. Since the acoustic resistance of the welding area, i.e. the interface between the two welds of the crack, is relatively large, a local high temperature will be generated. Because the plastic in the second inorganic encapsulation layer has a poor thermal conductivity, the heat cannot be dissipated in time and gathers in the welding area, causing the two contact surfaces to melt rapidly. After a certain pressure is applied by the high-voltage generator, they are fused into one. The vibration frequency of the high-frequency ultrasonic wave used in this embodiment is 40,000 times per second to 60,000 times per second. When the ultrasonic wave stops working, the pressure is allowed to continue for a few seconds for solidification and formation, thus forming a solid molecular chain, achieving the purpose of crack welding of the encapsulation layer, and the welding strength can be close to the strength of the original material. The quality of ultrasonic welding depends on three factors: the amplitude of the transducer welding head, the applied pressure, and the welding time. The welding time and welding head pressure can be adjusted. The amplitude is determined by the transducer and the amplitude transformer. The interaction of these three valuables has an appropriate value. When the energy exceeds the appropriate value, the melting amount of the encapsulation layer doped with thermoplastic plastic is relatively large and easy to deform. If the energy is small, it is not easy to weld firmly, and the applied pressure cannot be too large. This optimal pressure is the product of the side length of the welding part and the optimal pressure per 1 mm of the edge. Of course, the vibration frequency of the ultrasonic wave may also be adjusted according to the actual crack size, which is not limited here.

The display panel evaluated to have a crack with a preset condition in the ultrasonic detection procedure has been marked. Therefore, FIG. 9 is a further detailed flowchart of operation S10 illustrated in FIG. 8. As shown in FIG. 9, before the operation of irradiating the position of the crack with ultrasonic waves to complete the ultrasonic repair operation by local heating, the following operations are further included:

S12: confirming the location of the crack of the preset condition according to the test result file of the display panel.

The test result file includes the coordinate system information corresponding to the crack, as well as the specific information of the crack, so that the ultrasonic device can adjust the frequency of ultrasonic vibration accordingly.

FIG. 10 is a flowchart of operations after operation S12 illustrated in FIG. 8. As shown in FIG. 10, in order to make the encapsulation layer of the area having cracks more uniform after repair, the operation of irradiating the position of the crack with high-frequency ultrasonic waves to complete the ultrasonic repair operation by local heating includes:

S13: irradiating the coordinate point confirmed to have the crack of the preset condition and the area with a diameter of 100 um-200 um around the coordinate point with ultrasonic waves.

Further, the coordinate point of the crack of the preset condition is divided into a plurality of sub-coordinate points. FIG. 11 is a flowchart of another operation after operation S12 illustrated in FIG. 8. As shown in FIG. 11, the operation of irradiating the position of the crack with ultrasonic waves to complete the ultrasonic repair operation by local heating includes:

S14: based on the distributed positions of the plurality of sub-coordinate points, sequentially irradiating ultrasonic waves to complete the ultrasonic repair operation by local heating.

If a crack is generated in the encapsulation layer, the shape of the crack may be composed of multiple curved sub-cracks. Therefore, by first dividing the crack into multiple sub-coordinates and then irradiating them with ultrasonic waves in sequence, the crack can be repaired more quickly and more smoothly.

It should be noted that the limitations of the various operations involved in this solution are not to be interpreted to limit the order of the operations, under the premise of not affecting the implementation of the specific solution. The operations written earlier can be executed first, or later, or even at the same time with the operations written later. As long as this solution can be implemented, it should be regarded as falling in the scope of protection of this application.

It should be noted that the inventive concept of the present application can be formed into many embodiments, but the length of the application document is limited and so these embodiments cannot be enumerated one by one. Therefore, should no conflict be present, the various embodiments or technical features described above can be arbitrarily combined to form new embodiments. After the various embodiments or technical features are combined, the original technical effects may be enhanced.

The foregoing is a further detailed description of the present application with reference to some specific optional implementations, but it cannot be determined that the specific implementation of the present application is limited to these implementations. For those having ordinary skill in the technical field to which the present application pertains, several deductions or substitutions may be made without departing from the concept of the present application, and all these deductions or substitutions should be regarded as falling in the scope of protection of the present application.

What is claimed is:

1. An ultrasonic detection method for detecting an encapsulation layer of a display panel, comprising:
sending a piece of first ultrasonic information to the encapsulation layer of the display panel;
receiving a piece of second ultrasonic information fed back from the encapsulation layer of the display panel, and analyzing whether the encapsulation layer of the display panel has a crack of a preset condition according to the piece of second ultrasonic information;
in response to finding no crack of the preset condition in the encapsulation layer of the display panel, transferring the display panel to a next procedure;
in response to finding a crack of the preset condition in the encapsulation layer of the display panel, performing a subsequent preset operation according to a test result and a preset rule.

2. The ultrasonic detection method as recited in claim 1, further comprising the following operations prior to the operation of sending the piece of first ultra-sonic information to the encapsulation layer of the display panel:
transferring the display panel to a carrier;
recognizing, by the carrier, a mark of a specific shape of the display panel and a terminal ID of the display panel;
establishing a corresponding coordinate system according to the mark of the specific shape and tagging the terminal ID of the display panel.

3. The ultrasonic detection method as claimed in claim 2, wherein a back plate of the display panel comprises a metal layer on which a pattern is designed through photolithography and development as the terminal ID.

4. The ultrasonic detection method as recited in claim 2, wherein the operation of sending the piece of first ultrasonic information to the encapsulation layer of the display panel comprises:
based on the coordinate system, sending the piece of first ultrasonic information to the encapsulation layer of the display panel in a plurality of times in sequence;
wherein the operation of receiving the piece of second ultrasonic information fed back from the encapsulation layer of the display panel and analyzing whether the encapsulation layer of the display panel has the crack of the preset condition according to the second piece of ultrasonic information comprises:
comparing the received piece of second ultrasonic information with a preset condition;
determining whether the encapsulation layer of the display panel has a crack according to the comparison result;
tagging the display panel according to the determination.

5. The ultrasonic detection method as claimed in claim 4, wherein the operation of tagging the display panel according to the determination comprises electronically tagging an X-axis and a Y-axis of a position of the crack based on the coordinate system, and generating a test result file and recording the test result file together with the position of the crack into the terminal ID of the display panel, so that when the terminal ID is recognized, a recognition system is operative to display all information of the display panel and locate coordinates at which the crack is located thus facilitating viewing and subsequent operations.

6. The ultrasonic detection method as recited in claim 4, wherein the mark comprises information directed to an evaluated level of the crack, and wherein the operation of performing a subsequent preset operation according to the test result and the preset rule comprises:
in response to the evaluated level of the crack of the display panel not reaching a scrapping standard, performing an repair operation on the display panel;
in response to the evaluated level of the crack of the display panel reaching the scrapping standard, performing a scraping operation on the display panel.

7. The ultrasonic detection method as recited in claim 6, wherein the scrapping standard comprises: when the crack is a non-penetrating crack, with a length more than 10 um and less than 1 mm and a depth within 1000 angstroms, the crack is determined as repairable and not reading the scrapping standard; when the crack is one that penetrates the encapsulation layer, the crack is determined as not repairable and reaching the scrapping standard so that the display panel is to be directly scrapped.

8. The ultrasonic detection method as recited in claim 1, further comprising the following operations prior to the operation of sending the piece of first ultrasonic information to the encapsulation layer of the display panel:
arranging the ultrasonic device and the display panel opposite to each other, and controlling a distance separating an ultrasonic transmitter module of the ultrasonic detection device from the display panel to lie in the range of 10 cm˜30 cm.

9. An ultrasonic repair method for repairing an encapsulation layer of a display panel, the ultrasonic repair method comprising:
transferring the display panel having a crack of a preset condition to a corresponding location;
irradiating a position of the crack with ultrasonic waves to perform an ultrasonic repair operation by means of local heating.

10. The ultrasonic repair method as recited in claim 9, wherein he encapsulation layer of the display panel includes a first inorganic encapsulation layer, an organic encapsulation layer, and a second inorganic encapsulation layer; wherein the organic encapsulation layer is disposed between the first inorganic encapsulation layer and the second inorganic encapsulation layer; wherein there is further added an encapsulation cover plate to a side of the second inorganic encapsulation layer facing away from the first inorganic encapsulation layer to realize encapsulation of the entire display panel;
wherein the second inorganic encapsulation layer is doped with a material that is sensitive to ultrasonic welding.

11. The ultrasonic repair method as recited in claim 10, wherein the material sensitive to ultrasonic welding comprises thermoplastics.

12. The ultrasonic repair method as recited in claim 11, wherein the thermoplastics comprise non-crystalline plastics, comprising acrylonitrile-butadiene-styrene (ABS), poly(methyl methacrylate) (PMMA), polycarbonates (PC), and Polystyrene (PS).

13. The ultrasonic repair method as recited in claim 11, wherein the thermoplastics include semi-crystalline plastics, comprising polyamide (PA), polyethylene terephthalate (PET), cellulose acetate polymer (CA), polyoxymethylene (POM), polyethylene (PE), and polypropylene (PP).

14. The ultrasonic repair method as recited in claim 10, wherein the material sensitive to ultrasonic welding comprises a rigid material, comprising polystyrene (PS), polymethyl methacrylate (PMMA), and polyamide (PA).

15. The ultrasonic repair method as claimed in claim 10, wherein the second inorganic encapsulation layer is doped with non-woven fabrics, comprising plastic fabrics, polymer materials, coated paper, and mixed fabrics, for ultrasonic welding.

16. The ultrasonic repair method as recited in claim 9, further comprising the following operations prior to the operation of irradiating the position of the crack with ultrasonic waves to perform the ultrasonic repair operation by means of local heating:
confirming the position of the crack of the preset condition based on the coordinate system corresponding to the test result of the display panel.

17. The ultrasonic repair method as recited in claim 16, wherein the operation of irradiating the position of the crack with ultrasonic waves to perform the ultrasonic repair operation by means of local heating comprises:
irradiating a coordinate point confirmed to have the crack of the preset condition and an area with a diameter of 100 um-200 um around the coordinate point using ultrasonic waves.

18. The ultrasonic repair method as recited in claim 17, wherein the coordinate point at which the crack of the preset condition is located is divided into a plurality of sub-coordinate points, and wherein the operation of irradiating the position of the crack with ultrasonic waves to perform the ultrasonic repair operation by means of local heating comprises:
based on distributed positions of the plurality of sub-coordinate points, irradiating the plurality of sub-coordinate points with ultrasonic waves in sequence to perform the ultrasonic repair operation by means of local heating

19. An ultrasonic device, comprising an ultrasonic device body, a plurality of ultrasonic transmitter modules, a plurality of ultrasonic receiver modules, and a processor; wherein the processor is arranged on a side of the ultrasonic device body, wherein the plurality of ultrasonic transmitter modules and the plurality of ultrasonic receiver modules are arranged on the ultrasonic device body at intervals; wherein the plurality of ultrasonic transmitter modules are each operative to transmit a piece of first ultrasonic information; wherein the plurality of ultrasonic receiver modules are each operative to receive a piece of second ultrasonic information; wherein the plurality of ultrasonic transmitter modules and the plurality of ultrasonic receiver modules are in a signal connection with the processor;
wherein the ultrasonic device is configured for detecting an encapsulation layer of the display panel by:
sending a piece of first ultrasonic information to the encapsulation layer of the display panel;
receiving a piece of second ultrasonic information fed back from the encapsulation layer of the display panel, and analyzing whether the encapsulation layer of the display panel has a crack of a preset condition according to the piece of second ultrasonic information;
in response to finding no crack of the preset condition in the encapsulation layer of the display panel, transferring the display panel to a next procedure;
in response to finding a crack of the preset condition in the encapsulation layer of the display panel, performing a subsequent preset operation according to a test result and a preset rule.

20. The ultrasonic device as claimed in claim 19, further comprising:
a high-frequency current generator, configured to convert an input low-frequency current into an output high-frequency current, wherein a frequency range of the high-frequency current generator is identical with an ultrasonic frequency range of the ultrasonic device;
a transducer, configured to convert the high-frequency current into high-frequency mechanical vibrations or ultrasonic waves;
a welding tool, configured for transmitting ultrasonic energy to the display panel to be welded;
a base, configured to support the display panel to be welded so that the display panel to be welded is easily impacted by the ultrasonic waves; and
a high-voltage generator, configured to produce a certain pressure acted on the encapsulation layer to be repaired.
